(19) United States
(12) Patent Application Publication
(10) Pub. No.: US 2010/0072048 A1
(43) Pub. Date: Mar. 25, 2010

(54) KEY MECHANISM FOR ELECTRONIC DEVICE

(75) Inventors: ZHOU-QUAN ZUO, Shenzhen City (CN); XU MING, Shenzhen City (CN)

Correspondence Address: PCE INDUSTRY, INC.;ATT. Steven Reiss, 288 SOUTH MAYO AVENUE, CITY OF INDUSTRY, CA, 91789, US

(73) Assignees: SHENZHEN FUTAIHONG PRECISION INDUSTRY CO., LTD., ShenZhen City (CN); FIH (HONG KONG) LIMITED, Kowloon (HK)

(21) Appl. No.: 12/509,020

(22) Filed: Jul. 24, 2009

(30) Foreign Application Priority Data
Sep. 25, 2008 (CN) 200810304681.5

(51) Int. Cl. H01H 13/04

(52) U.S. Cl. 200/333

(57) ABSTRACT

A key mechanism is used in an electronic device, the electronic device includes a housing. The key mechanism includes a key cap made of elastic material. The key cap includes an edge and a protrusion. The edge is waterproofly connected to the housing. The protrusion allows a user to detect the key cap.

### BACKGROUND

1. Technical Field

The present disclosure relates to key mechanisms and, particularly, to a key mechanism for an electronic device, e.g., mobile phone, personal digital assistant (PDA), palm computer and etc.

2. Description of Related Art

With the development of wireless communication and information processing technologies, electronic devices, such as mobile telephones and electronic notebooks, are now in widespread use. These electronic devices enable consumers to enjoy high technology services, almost anytime and anywhere. A key mechanism as input mechanism is indispensable in many electronic devices.

A typical key mechanism for an electronic device includes an upper shell and a keypad. The upper shell defines a plurality of holes therethrough. The keypad includes a top surface and a plurality of keys arranged on the top surface. The keypad is mounted under the upper shell and each key is exposed through a corresponding hole of the upper shell.

However, dust and water may enter the electronic device through a gap between the upper shell and the keypad and damage inner circuitry of the electronic device.

Therefore, there is room for improvement within the art.

### BRIEF DESCRIPTION OF THE DRAWINGS

Many aspects of the key mechanism can be better understood with reference to the following drawings. These drawings are not necessarily drawn to scale, the emphasis instead being placed upon clearly illustrating the principles of the present key mechanism. Moreover, in the drawings like reference numerals designate corresponding sections throughout the several views.

FIG. 1 is an exploded, isometric view of the key mechanism in accordance with an exemplary embodiment.

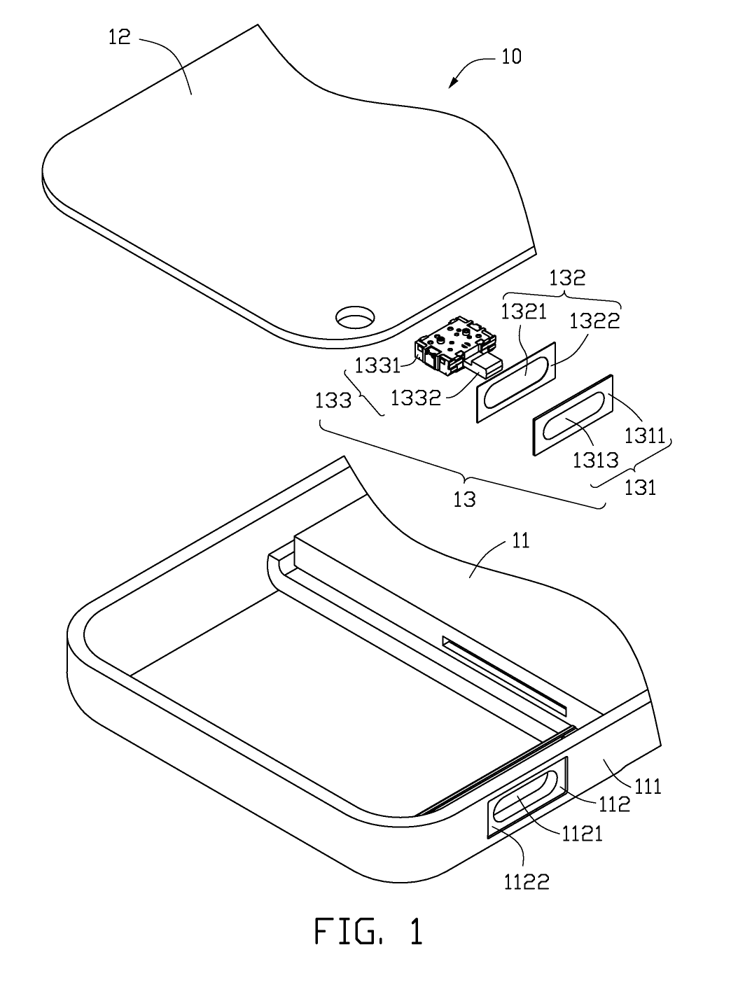

FIG. 2 is an assembled view of the key mechanism shown in FIG. 1.

FIG. 3 is a partially cross-sectional view of the key mechanism shown in FIG. 1.

### DETAILED DESCRIPTION

The present key mechanism is suitable for use in portable electronic devices, such as mobile phone terminals, digital cameras, and others. In an exemplary embodiment, a key mechanism 13 is used in a mobile phone 10. The mobile phone 10 includes a housing 11, a printed circuit board (PCB) 12, and the key mechanism 13. The printed circuit board 12 is fastened to the housing 11. The key mechanism 13 is mounted to the housing 11, and electrically connected to the PCB 12.

The housing 11 includes a sidewall 111. The sidewall 111 defines a receiving cavity 112 with a bottom wall 1121. The bottom wall 1121 defines a through hole 11 22. In the exemplary embodiment, the PCB 12 is screwed to the housing 11.

The key mechanism 13 includes a key cap 131, an adhesive 132, and a switch 133. The switch 133 is mounted within the housing 11, and electrically connected to the PCB 12. The key cap 131 is attached to the housing 11 by the adhesive 132, and used to operate the switch 133.

The key cap 131 is made of elastic material, e.g., polycarbonate (PC) and polyethylene terephthalate (PET). The key cap 131 is received in the receiving cavity 112. The key cap 131 is generally rectangular, and includes an edge 1311 and a protrusion 1313 surrounded by the edge 1311. The protrusion 1313 has a convex cross-section, and is deformable, that is, the protrusion 1313 can be manually deformed with an external force from a convex state to a concave state and then rebounds to the first configuration after the external force is released. The edge 1311 is mounted on the bottom wall 1121 by the adhesive 132, with the protrusion 1313 faces the hole 1122. The protrusion 1313 exposes out of the sidewall 111, thus allowing a user to detect the position of the key mechanism 13 and to operate the key mechanism 13.

The adhesive 132 can be glue, or double sided adhesive tape, and has a same shape and size as the edge 1311 of the key cap 131. The adhesive 132 defines an operating hole 1321, surrounded by a brim 1322. The brim 1322 is configured to adhere the edge 1311 of the key cap 131 to the bottom wall 1122 of the receiving cavity 112 so that the hole 1122 is sealed by the key cap 131.

The switch 133 includes a mounting portion 1331 and a contact portion 1322. The contact portion 1322 is adjacently aligned with the protrusion 1313. The contact portion 1322 can be selectively electrically connected to the PCB 12 when pressed by the protrusion 1313. The mounting portion 1331 is used to mount the switch 133 to the PCB 12.

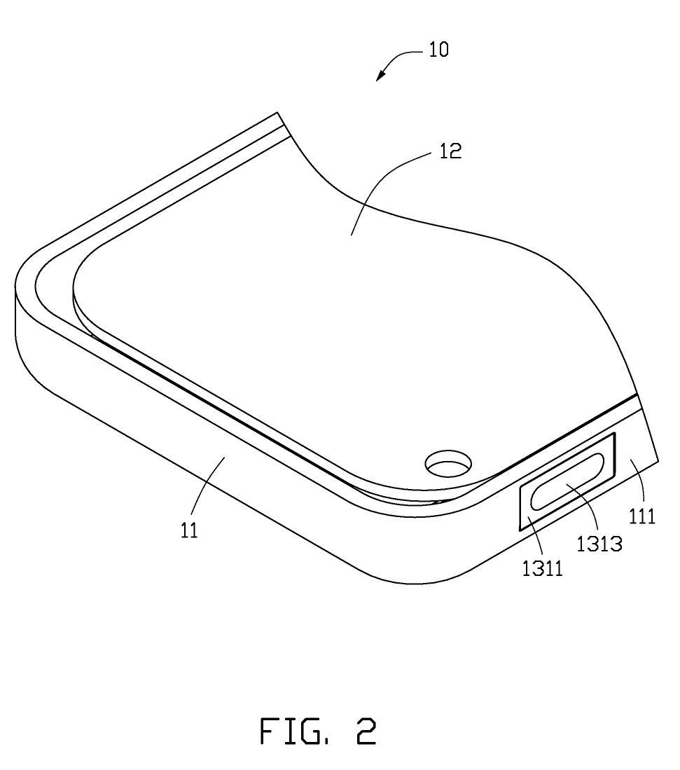

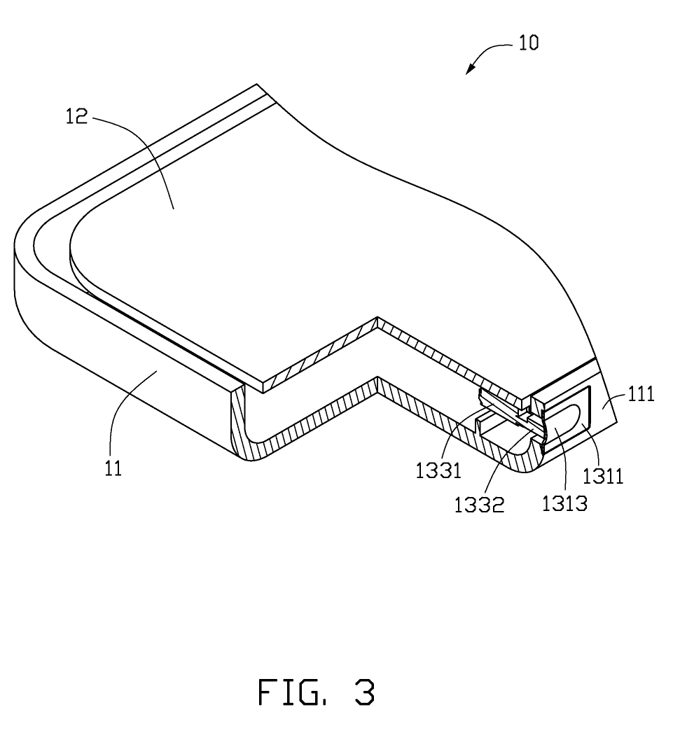

Referring to FIGS. 2 and 3 together, in assembly, the switch 133 is mounted within the housing 10, with the contact portion 1332 received in the through hole 1121. The key cap 131 is received in the receiving cavity 112, with the protrusion 1313 aligned with the through hole 1121 and the edge 1311 adhered to the brim 1322. Therefore, the key cap 131 can prevent water or dust from entering into the housing 10 through the through hole 1121.

In use, the protrusion 1313 is pressed towards the contact portion 1332 until the protrusion 1313 deforms abutting the contact portion 1332 and electrically connecting to the PCB 12, thus inputting information.

In other alternative embodiment, the key cap 131 can be attached to the sidewall 111 of the housing 11 by other ways, e.g., ultrasonic combination, insert-molding and etc. Meantime, the adhesive 12 is omitted.

In other alternative embodiment, the receiving cavity 112 can be defined in other positions, not limit to the sidewall 111.

It is to be understood, the key mechanism 13 can be used to protect other types of buttons besides the switch 133, e.g., buttons of a keypad.

It is to be understood, however, that even through numerous characteristics and advantages of the present disclosure have been set forth in the foregoing description, together with details of the structure and function of the disclosure, the disclosure is illustrative only, and changes may be made in detail, especially in matters of shape, size, and arrangement of sections within the principles of the disclosure to the full extent indicated by the broad general meaning of the terms, in which the appended claims are expressed.

What is claimed is:

1. A key mechanism used in an electronic device, the electronic device including a housing, the key mechanism comprising:
a key cap including an edge and an elastic protrusion, the edge being waterproofly connected to the housing, and the protrusion allowing a user to detect the key cap.

2. The key mechanism as claimed in claim 1, wherein the housing defines a receiving cavity with a bottom wall, the key cap is connected to the bottom wall.

3. The key mechanism as claimed in claim 2, wherein the key cap is adhered to the bottom wall.

4. The key mechanism as claimed in claim 2, wherein the key cap is combined to the bottom wall by ultrasonic welding.

5. The key mechanism as claimed in claim 2, wherein the housing includes a sidewall, the receiving cavity is defined on the sidewall, the bottom wall defines a through hole, the key mechanism includes a switch, the switch is mounted within the housing, facing the through hole, the protrusion exposes out of the sidewall.

6. The key mechanism as claimed in claim 1, wherein the key cap is made of polycarbonate.

7. The key mechanism as claimed in claim 1, wherein the key cap is made of polyethylene terephthalate.

8. A key mechanism used in an electronic device, the electronic device including a housing and a printed circuit board, the key mechanism comprising:
a key cap made of elastic material, the key cap including an edge and a protrusion, the edge being waterproofly connected to the housing, and the protrusion allowing a user to detect the key cap;
a switch used to contact the printed circuit board, the switch facing the protrusion.

9. The key mechanism as claimed in claim 8, wherein the housing defines a receiving cavity with a bottom wall, the key cap is connected to the bottom wall.

10. The key mechanism as claimed in claim 9, wherein the key cap is adhered to the bottom wall.

11. The key mechanism as claimed in claim 9, wherein the key cap is combined to the bottom wall by ultrasonic combination.

12. The key mechanism as claimed in claim 8, wherein the key cap is made of polycarbonate.

13. The key mechanism as claimed in claim 8, wherein the key cap is made of polyethylene terephthalate.
